(19) United States
(12) Patent Application Publication
(10) Pub. No.: US 2021/0245698 A1
(43) Pub. Date: Aug. 12, 2021

(54) FRAME FOR A VEHICLE SEAT, VEHICLE SEAT FOR A MOTOR VEHICLE

(71) Applicant: Volkswagen Aktiengesellschaft, Wolfsburg (DE)

(72) Inventors: Stefan HAGEN, Tappenbeck (DE); Annett GRESENS, Lehre (Flechtdorf) (DE); Bjoern ZIMMERMANN, Meine (DE); Daniel NAVARRO PEREZ, Gifhorn (DE); Alexander PACHONICK, Braunschweig (DE)

(73) Assignee: Volkswagen Aktiengesellschaft, Wolfsburg (DE)

(21) Appl. No.: 17/240,576

(22) Filed: Apr. 26, 2021

Related U.S. Application Data
(63) Continuation of application No. PCT/EP2019/079045, filed on Oct. 24, 2019.

(30) Foreign Application Priority Data
Oct. 25, 2018 (DE) 10 2018 218 292.2

(51) Int. Cl. B60R 21/207; B60N 2/68

(52) U.S. Cl. CPC B60R 21/207; B60N 2/682

(57) ABSTRACT

A frame for a vehicle seat, wherein the frame has two side elements and two transverse elements, wherein the transverse elements each connect two opposite free ends of the side elements to one another, with at least one flexible tension member that is tensioned diagonally across the frame in such a manner that a first end of the tension member is attached to one of the side elements and a second end of the tension member is attached to the other side element. Provision is made that at least one of the side elements has a projection that is associated with an attachment point of the tension member on the side element and that deflects the tension member, by which means the tension member is tensioned during attachment at the attachment point.

This nonprovisional application is a continuation of International Application No. PCT/EP2019/079045, which was filed on Oct. 24, 2019 and which claims priority to German Patent Application No. 10 2018 218 292.2, which was filed in Germany on Oct. 25, 2018 and which are both herein incorporated by reference.

### BACKGROUND OF THE INVENTION

### Field of the Invention

The present invention relates to a frame for a vehicle seat, wherein the frame has two side elements and two transverse elements, wherein the transverse elements each connect two opposite free ends of the side elements to one another, with at least one flexible tension member that is tensioned diagonally across the frame in such a manner that a first end of the tension member is attached to one of the side elements and a second end of the tension member is attached to the other side element.

In addition, the invention relates to a vehicle seat for a motor vehicle, with a backrest that has such a frame and cushioning that is supported by the frame.

Furthermore, the invention relates to a motor vehicle with multiple vehicle seats, at least one of which is designed as described above.

### Description of the Background Art

Frames for vehicle seats are already known from the prior art. Thus, for example, published patent application DE 196 50 503 A1 discloses a frame for a vehicle seat with two side sections that are connected to one another by a rigid top crosspiece. In addition, the frame has a reinforcing wire, which extends diagonally across the frame and can be loaded in tension in order to stiffen the frame so that a parallelogram-like displacement, in particular, of the top crosspiece of the frame relative to the bottom crosspiece of the frame is prevented or at least made more difficult. Another frame for a vehicle seat is known from published patent application GB 2 246 699 A, which likewise has a tension member that is tensioned diagonally.

### SUMMARY OF THE INVENTION

It is therefore an object of the present invention to provide a frame in which the tension member can easily be tensioned diagonally across the frame in order to facilitate assembly and improve the stiffness of the frame.

The object of the invention is attained by a frame characterized in that at least one of the side elements has a projection that is associated with an attachment point of the tension member on the side piece and that deflects the tension member, by which means the tension member is tensioned during attachment at the attachment point. As a result of the projection, the tension member is consequently bent or deflected from a direct, which is to say only straight, connection between the two side elements, so that a curvature is produced in the tension member. As a result of this curvature, it is made possible that a tension is exerted on the tension member in its longitudinal extent due to the spanning of the projection during attachment of the tension member to the side element, which ensures the desired tension.

The attachment point can be designed as a screw point, wherein the tension member has a screw opening through which a shank of an attachment screw is screwed into the screw point, in particular into a threaded sleeve of the screw point, wherein the tension member is secured between a screw head of the attachment screw and the side element. The tension member is thus tightly screwed on to the attachment point of the side element. As a result of the screwing operation, the end of the tension member is drawn toward the supporting surface on the side element when the attachment screw is screwed into the side element. In the process, the desired preloading, which ensures an advantageous stiffness of the frame, is applied to the tension member with the aid of the deflecting projection.

In addition, provision is preferably made that the projection is formed on a lateral edge of the side element. As a result, the lateral projection can be integrated easily into the structure of the frame. Advantageously, the tension member is deflected around the lateral edge of the side element so that the attachment point does not lie in the plane in which the tension member extends diagonally across the frame. Instead, the tension member has, at least at one of its ends, a deflection of approximately 90°. As a result, the attachment point is not formed on a back of the side section across which the tension member is tensioned, but rather on a side surface of the side section. As a result of the arrangement of the projection on the lateral edge of the side element, an especially advantageous deflection of the tension member is ensured.

In particular, the tension member is deflected at an acute angle by the projection. This occurs, in particular, when the projection is formed on the lateral edge of the side element as described above and the tension member is routed from the back of the side element to the side surface. It is possible to realize the acute deflection angle in a simple manner by means of the additional projection, in particular on the lateral edge. As a result, high tensile forces are ensured, which are achieved in an advantageous manner by the screw connection or the attachment of the free end of the tension member to the side element.

The tension member can be attached at an additional attachment point of the other side element, wherein the additional attachment point is likewise designed as a screw point such that the tension member is also screwed to the other side element. This results in simple overall assembly of the frame.

One of the attachment points can be associated with a central airbag mount of the frame, in particular is integrated therein. The frame thus has a central airbag mount, which is located in the region of one of the attachment points. As a result, the attachment point is located in a region of the frame that usually is designed to be stiffened in any case for mounting and accommodation of the central airbag, thus producing an advantageous attachment of the tension member and an advantageous action of the tensile force on the frame.

In addition, provision is preferably made that at least one of the attachment points is associated with a side airbag mount of the frame, in particular is integrated therein. The frame thus has a side airbag mount, wherein the—or an additional—attachment point for the tension member is arranged in the vicinity of the side airbag mount so that the aforementioned advantages with respect to increased stiffness are produced. Due to the integration of the attachment point in the side airbag mount or central airbag mount, a space-saving embodiment is produced, in which an attachment screw, for example, for arrangement of a side airbag or central airbag is additionally used by the frame for tensioning and attachment of the tension member to the frame.

Also provided is a vehicle seat is provided including the inventive frame. The aforementioned advantages are produced as a result.

In particular, the frame has a central airbag mount, in which a central airbag is attached. Especially preferably, the central airbag is attached to the frame by at least one attachment screw, wherein the attachment screw preferably also attaches the tension member at an attachment point of the frame provided for this purpose.

In particular, the central airbag mount is associated with a top transverse element of the frame. This produces the result that the tension member extends diagonally upward toward the central airbag mount. Because the central airbag mount or the central airbag usually faces the passenger compartment or a longitudinal center line of the vehicle, high stiffness of the frame, in particular in the event of a so-called far-side impact crash, is therefore ensured.

Preferably, the frame additionally has a side airbag mount, to which a side airbag is attached, and which is associated with the bottom transverse element. In particular, the additional attachment point for the tension member is also associated with the side airbag mount, as already mentioned above. The advantages already mentioned above are produced as a result. The tension member consequently extends from the side airbag mount to the central airbag mount, and is thus attached in especially stiff sections of the frame, thereby producing high robustness of the vehicle seat and the frame.

The motor vehicle according to the invention with the features of claim 12 is characterized in that at least one of the vehicle seats is designed in accordance with the invention. This produces the advantages already mentioned above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a motor vehicle with advantageous vehicle seats in a simplified perspective representation,

FIG. 2 shows a vehicle seat in a simplified rear view, and

FIG. 3 is a simplified sectional representation of the vehicle seat.

### DETAILED DESCRIPTION

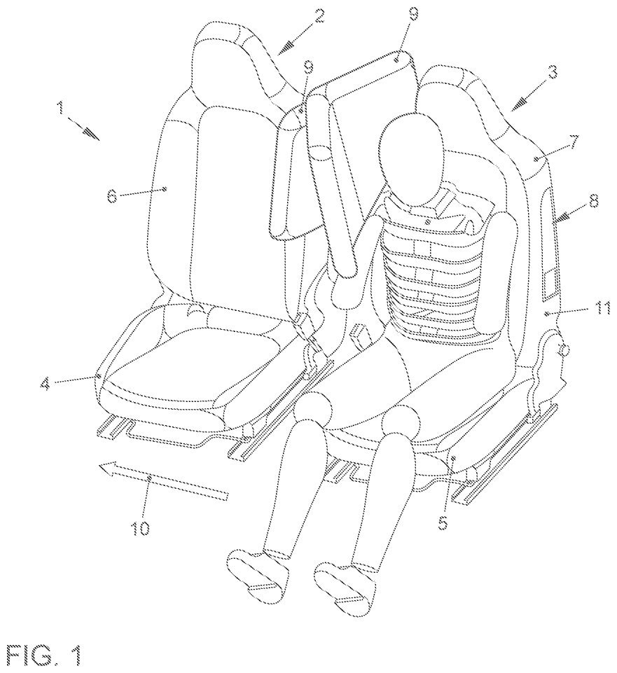

In a simplified perspective representation, FIG. 1 shows a perspective top view of the passenger compartment of a motor vehicle 1, in which two vehicle seats 2 and 3 are arranged next to one another. The two vehicle seats each have a seat part 4, 5 and a backrest 6, 7. Arranged on each backrest 6, 7 is a side airbag 8, which is arranged on a side surface of the respective backrest 7 or 6 located on the side of the respective vehicle seat 3, 2 facing away from the adjacent vehicle seat 2 or 3. On the side surfaces that face one another, the backrests 6, 7 each have a central airbag 9. In the event of a side collision, in particular in the event of a so-called far-side impact crash, a lateral direction of impact acts as shown by an arrow 10 in FIG. 1. In the event of such an impact, the central airbags 9, as shown in FIG. 1, are triggered and protect the people located on the vehicle seats 2, 3. In addition, forces occur that act on the backrests 6,7, in particular. In order to prevent the backrests from deforming in a parallelogram-like way, they have an advantageous device for improving their stiffness.

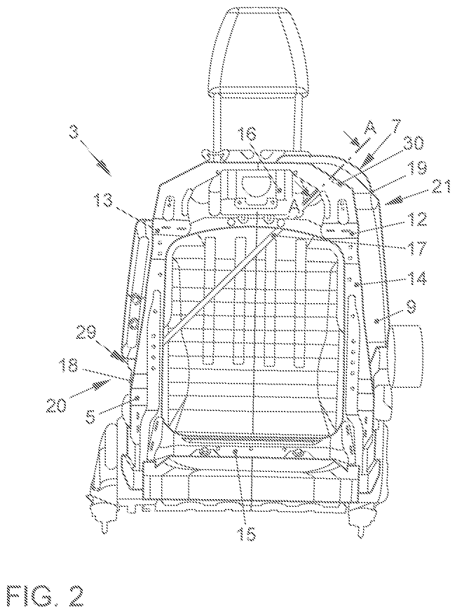

FIG. 2 shows a simplified rear view of the vehicle seat 3, wherein the vehicle seat 2 is designed as a mirror image thereof. The backrest 7 has cushioning 11 that is shown in FIG. 1 but is absent in FIG. 2. The cushioning 11 is supported by a frame 12 of the backrest 7. The frame 12 has two side elements 13, 14 arranged at a distance from and essentially parallel to one another, which are connected rigidly to one another by two transverse elements 15, 16. The bottom transverse element 15 here is designed to be somewhat longer than the top transverse element 16, which also serves as a support for a headrest. The transverse elements 15, 16 each connect two free ends of the side elements 13, 14 rigidly to one another, so that a stiff, essentially rectangular frame 12 is produced.

In order to increase the stiffness, the backrest 7 or the frame 12 has a tension member 17 that is tensioned diagonally across the frame 12. The tension member 17 is designed, in particular, as a flexible tension member 17, which is at least substantially inelastic or inextensible in the direction of tension. At both its ends, the tension member 17 is connected rigidly to the frame 12. For this purpose, a first end 18 is connected rigidly to the side element 13, and the second end 19 is connected rigidly to the side element 14. Provided on the side elements 13, 14 for this purpose are attachment points 20 and 21 respectively, to which the tension member 17 can be attached or is attached in each case.

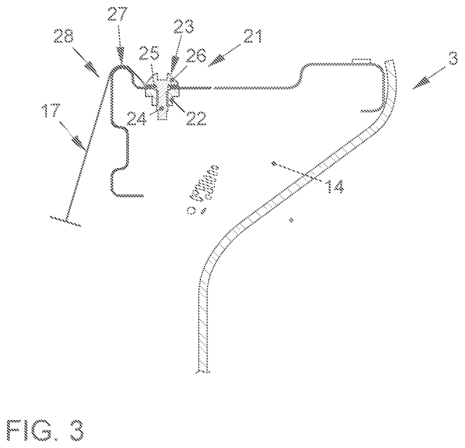

FIG. 3 shows the attachment point 21 on the side element 14 in an enlarged sectional detail representation along the line A-A from FIG. 2. The attachment point 21 is designed as a screw attachment point, for which purpose a screw thread 22 in the form of a threaded sleeve is arranged or formed on the side element 14. An attachment screw 23 with a screw shank 24 can be screwed into the screw thread 22. At its free end, the tension member 17 has a screw opening 25 through which the screw shank 24 can be passed and screwed into the screw thread 22, so that a screw head 26 of the attachment screw 23 secures the tension member 27 between the side element 14 and the screw head 26.

A projection 27 that deflects the tension member 17 is associated with the attachment point 21. This projection is formed on a lateral edge of the side element 14, in this case the lateral edge 28, which faces the adjacent side element 13. The projection 27 achieves the result that the tension member 17 is deflected by an acute angle about the projection 27 toward the attachment point 21 or from the attachment point 21 toward the adjacent side element 13.

If, during assembly, the free end of the tension member 17 is brought to the attachment point 21 and if it is already attached at the other attachment point 20, then screwing in the attachment screw 23 achieves the result that the tension member 17 is placed in tension by the projection 27. The frame stiffness is increased as a result.

The attachment points 20 and 21 in this case are integrated into mounts 29 or 30 respectively for the side airbag or the central airbag 9 so that the respective screw points perform a dual task or a dual function. This ensures a compact and very stiff design of the frame with simple assembly, in particular because the mounts 29, 30 further increase the stiffness of the frame in the region of the mount.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A frame for a vehicle seat, the frame comprising:
two side elements;
two transverse elements, the transverse elements each connect two opposite free ends of the side elements to one another;
at least one flexible tension member that is tensioned diagonally across the frame such that a first end of the tension member is attached to one of the side elements and a second end of the tension member is attached to the other side element,
wherein at least one of the side elements has a projection that is associated with an attachment point of the tension member on the side element and that deflects the tension member via which the tension member is tensioned during attachment at the attachment point.

2. The frame according to claim 1, wherein the attachment point is designed as a screw attachment point, wherein the tension member has a screw opening through which a shank of an attachment screw is screwed into the screw attachment point, wherein the tension member is secured between a screw head of the attachment screw and the side element.

3. The frame according to claim 1, wherein the projection is formed on a lateral edge of the side element.

4. The frame according to claim 1, wherein the tension member is deflected at an acute angle by the projection.

5. The frame according to claim 1, wherein both attachment points are designed as screw attachment points.

6. The frame according to claim 1, wherein one of the attachment points is associated with a side airbag mount of the frame or is integrated therein.

7. The frame according to claim 1, wherein one of the attachment points is associated with a central airbag mount of the frame or is integrated therein.

8. A vehicle seat for a motor vehicle, comprising:
a backrest that has a frame; and
a cushioning that is supported by the frame,
wherein the frame is the frame according to claim 1.

9. The vehicle seat according to claim 8, wherein the frame has a central airbag mount, and wherein a central airbag is attached to the central airbag mount.

10. The vehicle seat according to claim 8, wherein the central airbag mount is associated with the top transverse element of the frame.

11. The vehicle seat according to claim 8, wherein the frame has a side airbag mount to which a side airbag is attached, and which is associated with the bottom transverse element.

12. A motor vehicle comprising at least two vehicle seat, wherein at least one of the vehicle seats is the vehicle seat according to claim 8.
